(19) United States
(12) Patent Application Publication
(10) Pub. No.: US 2025/0024301 A1
(43) Pub. Date: Jan. 16, 2025

(54) INFORMATION INDICATION METHOD AND RECEIVING METHOD, APPARATUS, DEVICE, AND STORAGE MEDIUM

(71) Applicant: VIVO MOBILE COMMUNICATION CO., LTD., Guangdong (CN)

(72) Inventors: Jian YAO, Guangdong (CN); Dajie JIANG, Guangdong (CN); Na LI, Guangdong (CN)

(73) Assignee: VIVO MOBILE COMMUNICATION CO., LTD., Guangdong (CN)

(21) Appl. No.: 18/899,383

(22) Filed: Sep. 27, 2024

Related U.S. Application Data
(63) Continuation of application No. PCT/CN2023/084633, filed on Mar. 29, 2023.

(30) Foreign Application Priority Data
Mar. 31, 2022 (CN) 202210346273.6

(51) Int. Cl. H04W 24/10; H04B 7/06; H04W 76/28

(52) U.S. Cl. CPC H04W 24/10; H04B 7/06968; H04W 76/28

(57) ABSTRACT

This application discloses an information indication method and receiving method, an apparatus, a device, and a storage medium. The information indication method in embodiments of this application includes: A first device indicates first information to a second device, where the first information is used to indicate validity of a sensing measurement result, and the sensing measurement result is a measurement result obtained by performing sensing measurement on a target signal received by the first device.

### CROSS-REFERENCE TO RELATED APPLICATIONS

This application is a Bypass Continuation Application of PCT International Application No. PCT/CN2023/084633 filed on Mar. 29, 2023, which claims priority to Chinese Patent Application No. 202210346273.6, filed on Mar. 31, 2022 in China, which is incorporated herein by reference in its entirety.

### TECHNICAL FIELD

This application pertains to the field of communication technologies, and specifically relates to an information indication method and receiving method, an apparatus, a device, and a storage medium.

### BACKGROUND OF THE INVENTION

In addition to having a communication capability, a future mobile communication system (for example, the beyond 5th generation mobile communication technology (B5G) or the 6th generation mobile communication technology (6G)) has a sensing capability. The sensing capability (that is, one or more devices that have a sensing capability) can sense information such as a direction, a range, and/or a velocity of a target object by sending and receiving a wireless signal, or detect, track, identify, or image a target object, an event, an environment, or the like. However, currently, a person skilled in the art is still in a discussion stage of how to implement a sensing measurement technology, that is, how to implement sensing measurement remains a technical problem to be solved.

### SUMMARY OF THE INVENTION

According to a first aspect, an information indication method is provided, including the following step.

A first device indicates first information to a second device, where the first information is used to indicate validity of a sensing measurement result; and
the sensing measurement result is a measurement result obtained by performing sensing measurement on a target signal received by the first device.

According to a second aspect, an information obtaining method is provided, including the following step.

A second device obtains first information indicated by a first device, where the first information is used to indicate validity of a sensing measurement result; and
the sensing measurement result is a measurement result obtained by performing sensing measurement on a target signal received by the first device.

According to a third aspect, an information indication apparatus is provided, including:
an indication module, configured to indicate first information to a second device, where the first information is used to indicate validity of a sensing measurement result; and
the sensing measurement result is a measurement result obtained by performing sensing measurement on a target signal received by a first device.

According to a fourth aspect, an information obtaining apparatus is provided, including:
an obtaining module, configured to obtain first information indicated by a first device, where the first information is used to indicate validity of a sensing measurement result; and
the sensing measurement result is a measurement result obtained by performing sensing measurement on a target signal received by the first device.

According to a fifth aspect, a communication device is provided, where the communication device is a first device and includes a processor and a memory. The memory stores a program or an instruction that can be run on the processor, and the program or the instruction is executed by the processor to implement the steps of the information indication method according to the embodiments of this application.

According to a sixth aspect, a communication device is provided, where the communication device is a first device and includes a processor and a communication interface. The communication interface is configured to indicate first information to a second device, where the first information is used to indicate validity of a sensing measurement result; and
the sensing measurement result is a measurement result obtained by performing sensing measurement on a target signal received by the first device.

According to a seventh aspect, a communication device is provided, where the communication device is a second device and includes a processor and a memory. The memory stores a program or an instruction that can be run on the processor, and the program or the instruction is executed by the processor to implement the steps of the information obtaining method according to the embodiments of this application.

According to an eighth aspect, a communication device is provided, where the communication device is a second device and includes a processor and a communication interface. The communication interface is configured to obtain first information indicated by a first device, where the first information is used to indicate validity of a sensing measurement result; and
the sensing measurement result is a measurement result obtained by performing sensing measurement on a target signal received by the first device.

According to a ninth aspect, an information feedback system is provided, including a first device and a second device, where the first device is configured to perform the steps of the information indication method according to the first aspect, and the second device is configured to perform the steps of the information obtaining method according to the second aspect.

According to a tenth aspect, a readable storage medium is provided, where the readable storage medium stores a program or an instruction, and the program or the instruction is executed by a processor to implement the steps of the information indication method according to the embodiments of this application, or the steps of the information obtaining method according to the embodiments of this application.

According to an eleventh aspect, a chip is provided, where the chip includes a processor and a communication interface. The communication interface is coupled to the processor, and the processor is configured to run a program or an instruction to implement the information indication method according to the first aspect or the information obtaining method according to the second aspect.

According to a twelfth aspect, a computer program/program product is provided, where the computer program/program product is stored in a storage medium, and the computer program/program product is executed by at least one processor to implement the steps of the information indication method according to the first aspect, or the computer program/program product is executed by at least one processor to implement the steps of the information obtaining method according to the second aspect.

### BRIEF DESCRIPTION OF DRAWINGS

FIG. 1 is a block diagram of a wireless communication system to which the embodiments of this application may be applied;

FIG. 2 is a schematic diagram of wireless sensing according to an embodiment of this application;

FIG. 3 is another schematic diagram of wireless sensing according to an embodiment of this application;

FIG. 4 is a flowchart of an information indication method according to an embodiment of this application;

FIG. 5 is a flowchart of an information obtaining method according to an embodiment of this application;

FIG. 6 is a diagram of a structure of an information indication apparatus according to an embodiment of this application;

FIG. 7 is a diagram of a structure of an information obtaining apparatus according to an embodiment of this application;

FIG. 8 is a diagram of a structure of a communication device according to an embodiment of this application;

FIG. 9 is a diagram of a structure of another communication device according to an embodiment of this application; and

FIG. 10 is a diagram of a structure of another communication device according to an embodiment of this application.

### DETAILED DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in this specification and the claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the NR terminology is used in most of the following description, although these technologies can also be applied to applications other than the NR system application, such as the 6^{th} generation (6G) communication system.

FIG. 1 is a block diagram of a wireless communication system to which the embodiments of this application may be applied. The wireless communication system includes a terminal, a network side device, and a core network device.

In the embodiments of this application, the terminal may be a terminal-side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), or a smart home (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bracelet, a smart chain bracelet, a smart ring, a smart necklace, a smart anklet, or a smart chain anklet), a smart wrist strap, smart clothing, and the like. It should be noted that a specific type of the terminal is not limited in the embodiments of this application.

The network side device may include an access network device or a core network device. The access network device may also be referred to as a radio access network device, a radio access network (RAN), a radio access network function, or a radio access network unit. The access network device may include a base station, a wireless local area network (WLAN) access node, a Wi-Fi node, or the like. The base station may be referred to as a NodeB, an evolved NodeB (eNB), an access point, a base transceiver station (BTS), a radio base station, a radio transceiver, a basic service set (BSS), an extended service set (Extended Service Set, ESS), a home NodeB, a home evolved NodeB, a transmission reception point (TRP), an access point (AP), a relay, a reconfigurable intelligence surface (RIS), or another appropriate term in the art. As long as a same technical effect is achieved, the base station is not limited to a specified technical term. It should be noted that, in the embodiments of this application, only a base station in an NR system is used as an example, but a specific type of the base station is not limited.

The core network device may include but is not limited to at least one of the following: a core network node, a core network function, a mobility management entity (MME), an access management function (AMF), a session management function (SMF), a user plane function (UPF), a policy control function (PCF), a policy and charging rules function (PCRF) unit, an edge application server discovery function (EASDF), unified data management (UDM), unified data repository (UDR), a home subscriber server (HSS), a centralized network configuration (CNC), a network repository function (NRF), a network exposure function (NEF), a local NEF (Local NEF or L-NEF), a binding support function (BSF), an application function (AF), or the like. It should be noted that, in the embodiments of this application, only a core network device in an NR system is used as an example for description, and a specific type of the core network device is not limited.

In the embodiment of this application, the network side device and the terminal with sensing capabilities can sense information about a target object, such as an orientation, a range, and a velocity, or detect, track, identify, and image a target object, an event, an environment, and the like by sending and receiving a wireless signal. For example, in some scenarios or implementations, sensing categories may be shown in the following table:

TABLE 1

| Wireless sensing | | |
|---|---|---|
| category | Sensing function | Application scenario |
| Macro-sensing category | Weather, air quality, and the like | Meteorology, agriculture, and life services |
| | Stream of traffic (intersections) and | Smart city, intelligent transportation, and |
| | stream of people (subway | business services |
| | entrances) | |
| | Animal activities, migration, and | Animal husbandry, ecological environment |
| | the like | protection, and the like |
| | Target tracking, ranging, velocity | Many application scenarios for conventional |
| | measurement, contours, and the | radars |
| | like | |
| | Three-dimensional map | Intelligent driving, navigation, and smart city |
| | construction | |
| Refined-sensing | Action posture recognition | Intelligent interaction of smartphones, games, |
| category | | and smart home |
| | Heartbeat/breathing, and the like | Health and medical care |
| | Imaging, material detection, and | Security check, industry, and the like. |
| | the like | |

It should be noted that the sensing category shown in the foregoing Table 1 is merely an example for description, and a sensing measurement category is not limited in the embodiments of this application.

In addition, the embodiments of this application may be applied in a communication and sensing fusion application scenario where a communication system is integrated with a radar system. In the scenario, a typical joint design includes: spectrum coexistence, that is, the two systems work independently, and information exchange can be allowed to reduce mutual interference. In a case that a receive end is shared, that is, transmit ends of the two systems send respective signal waveforms, and the waveforms of the two systems need to be orthogonal, thus not affecting respective receiving and detection. In a case that a transmit end is shared, that is, the transmit end transmits a joint waveform of the radar system and the communication system. In a case that a transmit end and a receive end are shared, that is, resources are shared on the transmit end and the receive end of the two systems, and similarly, a joint waveform or waveforms in an orthogonal relationship need to be used. It should be noted that the foregoing communication and sensing fusion application scenario where the communication system is integrated with the radar system is an example of an application scenario of the embodiments of this application, and a corresponding scenario is not limited in the embodiments of this application.

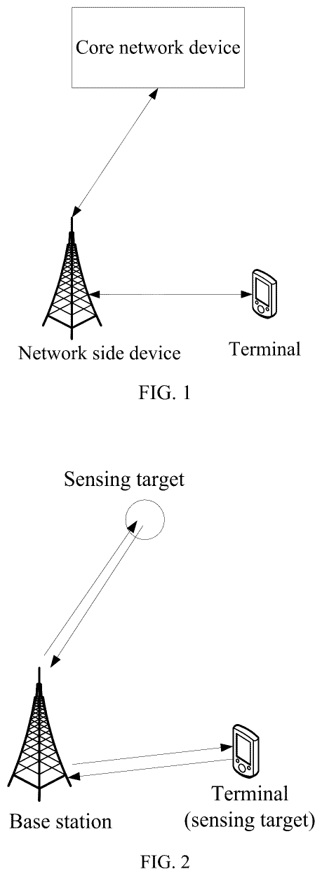

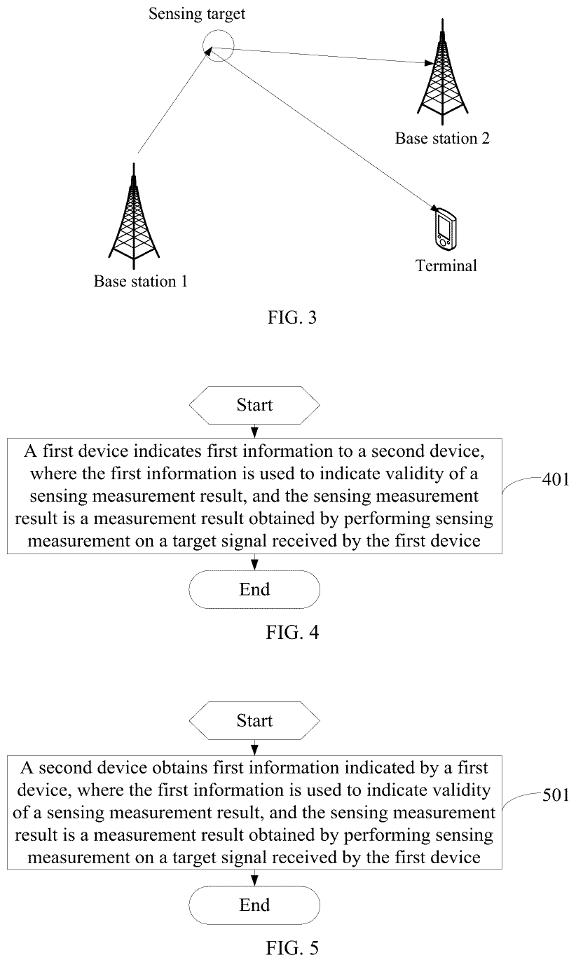

In the embodiments of this application, sensing may be performed based on a single-station mode, that is, transmit/receive co-location. A transmit end transmits a sensing signal, and then receives an echo signal and analyzes the echo signal to extract a sensing parameter, for example, as shown in FIG. 2, a base station is used as a transmit end and a receive end of the sensing signal, and a terminal or another object is used as a sensing target. Alternatively, sensing may be performed based on a dual-station/multi-station mode, that is, transmission and receiving do not use a same address. A transmit end transmits a sensing signal, and another receive end receives and analyzes the sensing signal to extract a sensing parameter, for example, as shown in FIG. 3, a base station 1 is used as a transmit end of the sensing signal, and a terminal or a base station 2 is used as a receive end of the sensing signal.

In the embodiments of this application, a communication system may jointly send a modulation symbol that carries information and a pilot symbol that is used for channel estimation, and focuses on decoding performance. A channel estimation algorithm of the communication system only needs to estimate a composite channel that has finite unknown parameters, and generally an optimization objective is to improve a throughput and transmission reliability. Performance indicators that are concerned are usually spectrum efficiency, a channel capacity, a signal-to-noise ratio (SNR), a signal to interference plus noise ratio (SINR), a bit error ratio (BER), a block error rate (BLER), a symbol error rate (SER), and the like. However, information carrying is not considered in a signal sending process of a sensing system. Generally, an optimized or unmodulated transmit signal is used, and a change (namely, a response feature) that is brought by a sensing target to the transmit signal is focused. Generally, an optimization target is to improve parameter estimation precision. A performance measurement indicator may be a fuzzy function, a Cramer-Rao lower bound, a root mean square error, mutual information, a rate distortion function, a radar estimation rate, a Welch lower bound, and some indicators associated with a sensing scenario and requirement.

In the embodiments of this application, in some scenarios or implementations, both a wireless communication signal and a wireless sensing signal are supported, and an integrated design of communication and sensing functions is implemented by using a manner of integrated sensing and communication such as a joint design of signals and/or hardware sharing, to both transfer information and have a sensing capability or provide a sensing service. In this way, the following effects may be achieved through integrated communication and sensing: saving costs, reducing a size of a device, reducing power consumption of a device, improving spectrum efficiency, and reducing mutual interference between sensing and communication to improve system performance.

In addition, integrated communication and sensing may include but is not limited to at least one of the following:
a same network provides a communication service and a sensing service;
a same terminal provides a communication service and a sensing service;
a same spectrum provides a communication service and a sensing service; or
an integrated communication and sensing service is completed in a same radio transmission, that is, a joint design of a communication signal and a sensing signal.

In the embodiments of this application, for a communication and sensing fusion scenario or an integrated communication and sensing scenario, a dedicated sensing signal may be used for sensing measurement, or a communication signal, such as data and/or a pilot, may be multiplexed. For use of a sensing measurement signal, a sender may instruct a receiver, for example, a base station instructs a terminal to perform sensing measurement by using a signal of that type.

An information indication method and receiving method, an apparatus, a device, and a storage medium provided in the embodiments of this application are described below in detail through some embodiments and application scenarios thereof with reference to the accompanying drawings.

FIG. 4 is a flowchart of an information indication method according to an embodiment of this application. As shown in FIG. 4, the method includes the following steps:

Step 401: A first device indicates first information to a second device, where the first information is used to indicate validity of a sensing measurement result; and
the sensing measurement result is a measurement result obtained by performing sensing measurement on a target signal received by the first device.

The foregoing first device may be a network side device or a terminal, and the foregoing second device may be a sensing network function and/or a sensing network element of a core network, or may be a network side device or a terminal.

In this embodiment of this application, the target signal may be a communication signal, such as a reference signal, a synchronization signal, or a data signal; or the target signal may be a dedicated sensing signal, such as a radar pulse signal or a frequency modulated continuous wave (FMCW) signal.

The receiving and sending of the target signal may include the following several manners:

A network side device A sends the target signal, and a network side device B receives the target signal, where the network side device B serves as the first device, and the network side device A serves as the second device; or at least one of the network side device A and the network side device B serves as the first device, and the core network serves as the second device.

The network side device sends the target signal, and the terminal receives the target signal, where the terminal serves as the first device, and the network side device serves as the second device; or at least one of the network side device and the terminal serves as the first device, and the core network serves as the second device.

The network side device sends and receives the target signal, where the network side device serves as the first device, and the core network serves as the second device.

The terminal sends and receives the target signal, where the terminal serves as the first device, and the network side device serves as the second device; or the terminal serves as the first device, and the core network serves as the second device.

The terminal sends the target signal and the network side device receives the target signal, where the network side device serves as the first device, and the core network serves as the second device.

A terminal A sends the target signal and a terminal B receives the target signal, where the terminal B serves as the first device, and the terminal A serves as the second device; the terminal A or the terminal B serves as the first device, and an access network side device of the terminal A or the terminal B serves as the second device; or the terminal A or the terminal B serves as the first device, and the core network serves as the second device.

It should be noted that a sending device of the target signal in this embodiment of this application may be a plurality of devices, and a receiving device of the target signal may be a plurality of devices.

The foregoing first information may indicate the validity of the sensing measurement result in an explicit or implicit manner.

The foregoing validity of the sensing measurement result is used to indicate that the sensing measurement result is valid or invalid, and each sensing measurement result or each indication of the validity of the sensing measurement result is associated with one or more sensing measurements, where one sensing measurement may be a measurement based on one or more target signals.

In addition, a criterion for the validity or invalidity of the sensing measurement result may be configured by a network device and/or defined by a protocol, or a criterion for the validity or invalidity of the sensing measurement result is determined by an associated sensing measurement item, sensing requirement or sensing service.

In this embodiment of this application, through the foregoing step, the validity of the sensing measurement result may be fed back to the second device, so as to implement sensing measurement, thereby improving operating performance of the device.

In addition, in this embodiment of this application, content indicated by the foregoing first information further facilitates the second device that receives the first information to further process or adjust a signal configuration of the sensing measurement result, so as to improve sensing measurement performance. Alternatively, the content indicated by the foregoing first information may assist a party that receives the sensing measurement result to further process the sensing measurement result, or adjust a configuration of a sensing measurement signal, so as to obtain better sensing measurement performance.

In an optional implementation, the first information includes an indication bit, and the indication bit is at least one bit and is used to indicate validity of a sensing measurement result.

In this implementation, the validity of the sensing measurement result may be directly indicated by using the indication bit.

In an implementation, the indication bit is one bit, where a first value of the bit indicates that the sensing measurement result is valid, and a second value of the bit indicates that the sensing measurement result is invalid.

In this implementation, the bit indicates the validity of the sensing measurement result. For example, “0” indicates that the sensing measurement result is invalid, and “1” indicates that the sensing measurement result is valid.

In an implementation, the indication bit is m bits, where m is an integer greater than 1, and the m bits indicate a validity level of the sensing measurement result.

The foregoing validity level of the sensing measurement result may be that different levels correspond to different signal quality, and the signal quality may include at least one of the following: an SNR, a reference signal receive power (RSRP), a received signal strength indication (RSSI), a signal clutter ratio, or the like. Alternatively, the foregoing validity level of the sensing measurement result may be that different levels correspond to different sensing performance indicators. Alternatively, the foregoing validity level of the sensing measurement result may be that different levels correspond to different measurement result validity thresholds. For example, it is assumed that there are two thresholds, including three levels: one level represents invalid, another level represents valid for a first threshold but invalid for a second threshold, and another level represents valid for a second threshold (it is assumed that the second threshold has a higher requirement).

In this implementation, it may be implemented that the validity of the sensing measurement result is classified into different levels, so that a feedback effect of the validity of the sensing measurement result can be improved.

In an optional implementation, that a first device indicates validity of a sensing measurement result to a second device includes:

The first device indicates the validity of the sensing measurement result to the second device through a discontinuous transmission (DTX).

The foregoing DTX may be fed back in a case that the first device detects no target signal or at least one of an SNR, an RSRP, an RSSI, or a signal clutter ratio of the detected target signal does not meet the threshold requirement, that is, signal sending is not performed on a specified feedback channel time-frequency resource, so as to indicate the first information to the second device.

For example, in a case that the sensing measurement result is invalid, the first device does not send a signal on a first feedback resource that is used to indicate validity of a sensing measurement result, so as to indicate through a DTX that the sensing measurement result is invalid to the second device.

In this implementation, it may be implemented that the first information is indicated to the second device through the DTX, thereby saving transmission overheads. For example, in a case that the sensing measurement result is valid, the first device sends first indication information on a first feedback resource that is used to indicate validity of a sensing measurement result, so as to indicate that the sensing measurement result is valid.

In an optional implementation, the first information is further used to indicate at least one of the following:
a reason for invalidity of the sensing measurement result; or
a parameter configuration of the target signal.

The foregoing reason for the invalidity of the sensing measurement result is used to indicate reason information of the invalidity of the sensing measurement result.

The foregoing parameter configuration of the target signal may be a parameter configuration that is recommended or expected by the first device to send the target signal, and the parameter configuration may be used to improve validity of a sensing measurement result corresponding to the target signal.

In this implementation, feeding back the foregoing at least one of the reason for the invalidity or the parameter configuration may facilitate the second device that receives the first information to further process the sensing measurement result or adjust a signal configuration of the sensing measurement result, so as to improve sensing measurement performance. Alternatively, the foregoing at least one of the reason for the invalidity or the parameter configuration may assist a party that receives the sensing measurement result to further process the sensing measurement result, or adjust a configuration of a sensing measurement signal, so as to obtain better sensing measurement performance.

Optionally, the reason for the invalidity of the sensing measurement result includes at least one of the following:
quality of the target signal detected by the first device does not meet a threshold requirement;
the sensing measurement result obtained by the first device does not meet a sensing requirement;
in a case that the target signal is a communication data signal, the first device does not demodulate the data correctly; or
when a feedback time point of the first information arrives, the first device does not obtain the sensing measurement result.

That the foregoing quality of the target signal detected by the first device does not meet a threshold requirement may be that at least one of an SNR, an RSRP, an RSSI, or a signal clutter ratio of the target signal detected by the first device does not meet the threshold requirement. In addition, in a measurement process, a receive end may first measure only the at least one of the SNR, the RSRP, the RSSI, or the signal clutter ratio, and then measure a specific sensing measurement item in a case that a threshold is reached.

That the foregoing sensing measurement result obtained by the first device does not meet a sensing requirement may be that a sensing performance indicator corresponding to the sensing measurement result obtained by the first device does not meet the requirement, for example, a sensing SNR is less than a preset threshold.

That the foregoing first device does not correctly demodulate the data may be that, when performing sensing based on the communication data, a manner in which a sensing parameter is first demodulated and then estimated is used. If communication demodulation fails, the sensing measurement result is affected and becomes unreliable, that is, the sensing measurement result is invalid.

That when a feedback time point of the first information arrives, the first device does not obtain the sensing measurement result may be that when the feedback time point of the first information arrives, a receive end fails to obtain the sensing measurement result, for example, the sensing measurement result processing times out.

In this implementation, it may be implemented that a specific reason for the invalidity of the sensing measurement result is indicated to the second device, so as to further improve a feedback effect.

Optionally, the parameter configuration includes at least one of the following:
a waveform, subcarrier spacing, a guard interval, a bandwidth, burst duration, a time domain interval, transmit signal power, a signal format, a signal direction, a time resource, a frequency domain resource, or a quasi co-location (QCL) relationship.

The foregoing waveform may include: orthogonal frequency division multiplex (OFDM), single-carrier frequency-division multiple access (SC-FDMA), or orthogonal time frequency space (OTFS), frequency modulated continuous wave (FMCW), and a pulse signal.

The foregoing subcarrier spacing may be subcarrier spacing of 30 KHz, 15 KHz, or the like of an OFDM system.

The foregoing guard interval may be a time interval between a moment at which sending of a signal ends and a moment at which a latest echo signal of the signal is received. The parameter is proportional to a maximum sensing range, and for example, may be calculated by using 2 dmax/c, where dmax is the maximum sensing range (which belongs to a sensing requirement). For example, for a self-transmitted and self-received sensing signal, dmax represents a maximum range from a receiving point of the sensing signal to a signal transmitting point. In some cases, an OFDM signal cyclic prefix (CP) may function as a minimum guard interval, and c is a velocity of light.

The foregoing bandwidth may be inversely proportional to a range resolution and may be obtained by using c/2/delta_d, where delta_d is the range resolution (which belongs to a sensing requirement).

The foregoing burst duration may be inversely proportional to a rate resolution (which belongs to a sensing requirement), and the parameter is a time span of the sensing signal and is mainly used to calculate a Doppler frequency shift; and the parameter may be calculated by using c/2/delta_v/fc, where delta_v is a velocity resolution, and fc is a signal carrier frequency or a center frequency of the signal.

The foregoing time domain interval may be calculated by using c/2/fc/v_range, where v_range equals a maximum velocity minus a minimum velocity (which belongs to a sensing requirement). This parameter is a time interval between two adjacent sensing signals.

The foregoing transmit signal power may be a value obtained at intervals of 2 dBm from −20 dBm to 23 dBm. Certainly, this is merely an example, and may be specifically set according to an actual requirement.

The foregoing signal format may be a sounding reference signal (SRS), a demodulation reference signal (DMRS), a positioning reference signal (PRS), or the like, or another predefined signal, a related sequence format, and other information.

The foregoing signal direction may be direction information or beam information of the sensing signal.

The foregoing time resource may include a slot index or a symbol index of a slot where the sensing signal is located. There are two types of time resources: one is a one-time time resource, for example, one symbol sends an omnidirectional target signal. The other is a non-one-time time resource, such as a plurality of groups of periodic time resources or discontinuous time resources (which may include a start time and an end time), where each group of periodic time resources sends sensing signals in a same direction, and beam directions of periodic time resources in different groups are different.

The foregoing frequency resource may include a center frequency, a bandwidth, a resource block (RB), a subcarrier, or the like of the sensing signal.

The foregoing QCL relationship may include: each resource of a plurality of resources that are included in the sensing signal is QCL with one synchronization signal block (SSB), where QCL includes a type A, B, C, or D.

In this implementation, based on the foregoing parameter configuration, the second device may be enabled to adjust a configuration of a sensing measurement signal, so as to obtain better sensing measurement performance.

In an optional implementation, the first information is further used to indicate at least one of the following:
identification information of the target signal associated with the sensing measurement result;
identification information of a sensing measurement; or
the sensing measurement result.

The foregoing identification information of the target signal associated with the sensing measurement result indicates that indication information of the validity of the sensing measurement result indicates validity of a sensing measurement result corresponding to one or more target signals. In this way, validity of a sensing measurement result that indicates a specific target signal may be implemented, so as to implement accurate indication.

The foregoing identification information of the sensing measurement may indicate that indication information of the validity of the sensing measurement result indicates validity of a sensing measurement result corresponding to a specific sensing measurement. The sensing measurement may be a measurement based on one or more target signals. In this way, the validity of the sensing measurement result that indicates the specific sensing measurement may be indicated, so as to implement accurate indication.

Indicating the foregoing sensing measurement result may implement indication of a specific sensing measurement result.

In an optional implementation, in a case that the sensing measurement result is valid, the first device indicates the first information to the second device; and in a case that the sensing measurement result is invalid, the first device does not send the first information to the second device; or
in a case that the sensing measurement result is invalid, the first device indicates the first information to the second device; and in a case that the sensing measurement result is valid, the first device does not indicate the first information to the second device.

In this implementation, it may be implemented that only when the sensing measurement result is valid, the first information is indicated to the second device, and when the sensing measurement result is invalid, the first information is not indicated, so as to implicitly indicate that the sensing measurement result is invalid, so as to save transmission overheads.

Further, it may be implemented that only when the sensing measurement result is invalid, the first information is indicated to the second device, and when the sensing measurement result is valid, the first information is not indicated, so as to implicitly indicate that the sensing measurement result is valid, so as to save transmission overheads.

In an optional implementation, in a case that the first information indicates that the sensing measurement result is invalid, the first information is further used to indicate at least one of the following:
a reason for invalidity of the sensing measurement result; or
a parameter configuration of the target signal; or
in a case that the first information indicates that the sensing measurement result is valid, the first information is further used to indicate at least one of the following:
the sensing measurement result.

In this implementation, it may be implemented that only when the first information indicates that the sensing measurement result is invalid, the first information indicates at least one of the reason for the invalidity of the sensing measurement result and the parameter configuration of the target signal; and when the sensing measurement result is valid, the first information indicates the sensing measurement result, so as to save transmission overheads.

In an optional implementation, before a first device indicates first information to a second device, the method further includes:
the first device receives second information sent by the second device, where the second information is used to indicate at least one of the following:
whether feedback on the validity of the sensing measurement result is needed;
a rule for feedback on the validity of the sensing measurement result;
a criterion for determining the validity of the sensing measurement result;
a sensing measurement item;
a sensing requirement; or a sensing service.

That whether feedback on the validity of the sensing measurement result is needed may be that whether validity feedback needs to be performed on all or a part of the sensing measurement result within a period of time (for example, from a current moment to a termination of the sensing service) is indicated.

The foregoing criterion for determining the validity of the sensing measurement result includes at least one of the following:
feedback timing;
a feedback resource;
a feedback manner; or
a format of the first information.

The foregoing feedback timing may represent a time length between a feedback time point and a reference time point (for example, a sending/ending time of a target signal or control information of a target signal).

The foregoing feedback resource may indicate a physical uplink control channel (PUCCH) and/or a physical uplink shared channel (PUSCH), which is equivalent to a specific time-frequency domain resource corresponding to the first information.

The foregoing feedback manner may include:
event trigger feedback, for example, the first information sent only when the sensing measurement result is invalid or valid as described in the foregoing implementations;
periodically triggered feedback, for example, the first device sends the first information at a specific period; and
message triggered feedback, for example, the first device sends the first information based on an indication message of the second device.

The foregoing criterion for determining the validity of the sensing measurement result may include at least one of the following:
whether quality of the target signal detected by the first device meets a threshold requirement;
whether the sensing measurement result obtained by the first device meets a sensing requirement;
in a case that the target signal is a communication data signal, whether the first device demodulates the data correctly; or
when a feedback time point of the first information arrives, whether the first device obtains the sensing measurement result.

The foregoing criterion for determining the validity of the sensing measurement result may refer to corresponding descriptions in the foregoing implementations. Details are not described herein again. In addition, quality threshold information of the target signal and performance indicator requirement information of the sensing measurement result may further be included.

The foregoing at least one of the sensing measurement item, the sensing requirement, and the sensing service may be used to indirectly indicate the criterion for determining the validity of the sensing measurement result of the first device. For example, the criterion for determining the validity or the invalidity of the sensing measurement result as described in the foregoing implementations may be associated with at least one of the sensing measurement item, the sensing requirement, and the sensing service.

In an optional implementation, before a first device indicates first information to a second device, the method further includes:

The first device receives third information sent by the second device, where the third information is used to indicate at least one of the following:
indication information that indicates whether sensing measurement is allowed to be performed based on a communication data signal;
configuration information of a communication data signal obtained by performing sensing measurement; or
sensing quality of service (QOS) information.

Based on the foregoing indication information that indicates whether sensing measurement is allowed to be performed based on the communication data signal, accuracy of sensing measurement by the first device may be improved. Based on the foregoing configuration information of the communication data signal obtained by performing sensing measurement, accuracy of sensing measurement by the first device may also be improved.

The foregoing sensing QOS information may include at least one of the following:
a priority of a sensing/integrated communication and sensing service, a sensing resolution requirement, a sensing precision or sensing error requirement, a sensing delay budget, a maximum sensing range requirement, a continuous sensing capability requirement, a sensing update frequency requirement, a detection probability, a false alarm probability, a missing detection probability requirement, or the like.

In this way, the first device may determine, based on the QoS information, a specific sensing signal or data or data symbol is to be used, thereby improving flexibility of sensing measurement.

In the embodiments of this application, a first device indicates first information to a second device, where the first information is used to indicate validity of a sensing measurement result, and the sensing measurement result is a measurement result obtained by performing sensing measurement on a target signal received by the first device. In this way, the first device indicates the validity of the sensing measurement result to the second device, so as to implement the sensing measurement.

FIG. 5 is a flowchart of an information obtaining method according to an embodiment of this application. As shown in FIG. 5, the method includes the following steps.

Step 501: A second device obtains first information indicated by a first device, where the first information is used to indicate validity of a sensing measurement result; and
the sensing measurement result is a measurement result obtained by performing sensing measurement on a target signal received by the first device.

Optionally, the first information includes an indication bit, and the indication bit is at least one bit and is used to indicate validity of a sensing measurement result.

Optionally, the indication bit is one bit, where a first value of the bit indicates that the sensing measurement result is valid, and a second value of the bit indicates that the sensing measurement result is invalid.

Optionally, the indication bit is m bits, where m is an integer greater than 1, and the m bits indicate a validity level of the sensing measurement result.

Optionally, that a second device obtains first information indicated by a first device includes:

The second device obtains the first information through a discontinuous transmission (DTX) of the first device.

Optionally, in a case that the sensing measurement result is invalid, the second device does not detect a signal sent by the first device on a first feedback resource that is used to indicate validity of a sensing measurement result, so as to determine through the DTX that the sensing measurement result is invalid.

Optionally, the first information is further used to indicate at least one of the following:
a reason for invalidity of the sensing measurement result; or
a parameter configuration of the target signal.

Optionally, the reason for the invalidity of the sensing measurement result includes at least one of the following:
quality of the target signal detected by the first device does not meet a threshold requirement;
the sensing measurement result obtained by the first device does not meet a sensing requirement;
in a case that the target signal is a communication data signal, the first device does not demodulate the data correctly; or
when a feedback time point of the first information arrives, the first device does not obtain the sensing measurement result.

Optionally, the parameter configuration includes at least one of the following:
a waveform, subcarrier spacing, a guard interval, a bandwidth, burst duration, a time domain interval, transmit signal power, a signal format, a signal direction, a time resource, a frequency domain resource, or a quasi co-location (QCL) relationship.

Optionally, the first information is further used to indicate at least one of the following:
identification information of the target signal associated with the sensing measurement result;
identification information of a sensing measurement; or
the sensing measurement result.

Optionally, in a case that the first information indicates that the sensing measurement result is invalid, the first information is further used to indicate at least one of the following:
a reason for invalidity of the sensing measurement result; or
a parameter configuration of the target signal; or
in a case that the first information indicates that the sensing measurement result is valid, the first information is further used to indicate at least one of the following:
the sensing measurement result.

Optionally, before a second device obtains first information indicated by a first device, the method further includes:

The second device sends second information to the first device, where the second information is used to indicate at least one of the following:

whether feedback on the validity of the sensing measurement result is needed;
a rule for feedback on the validity of the sensing measurement result;
a criterion for determining the validity of the sensing measurement result;
a sensing measurement item;
a sensing requirement; or
a sensing service.

Optionally, the rule for feedback on the validity of the sensing measurement result includes at least one of the following:
feedback timing;
a feedback resource;
a feedback manner; or
a format of the first information; or
the criterion for determining the validity of the sensing measurement result includes at least one of the following:
whether quality of the target signal detected by the first device meets a threshold requirement;
whether the sensing measurement result obtained by the first device meets a sensing requirement;
in a case that the target signal is a communication data signal, whether the first device demodulates the data correctly; or
when a feedback time point of the first information arrives, whether the first device obtains the sensing measurement result.

Optionally, before a second device obtains first information indicated by a first device, the method further includes:

The second device sends third information to the first device, where the third information is used to indicate at least one of the following:
indication information that indicates whether sensing measurement is allowed to be performed based on a communication data signal;
configuration information of a communication data signal obtained by performing sensing measurement; or sensing quality of service (QOS) information.

It should be noted that this embodiment is used as an implementation of the second device corresponding to the embodiment shown in FIG. 4. For a specific implementation, refer to the related descriptions in the embodiment shown in FIG. 4. To avoid repeated description, details are not described again in this embodiment.

The following uses several embodiments to illustrate the methods according to the embodiments of this application.

### Embodiment 1

This embodiment mainly describes a format of first information, which may be specifically as follows:

In this embodiment, a validity indication of a single sensing measurement result is fed back each time, where each sensing measurement result (or the validity indication of each sensing measurement result) is associated with one or more sensing measurements, and one sensing measurement may be a measurement based on one or more target signals.

The format of the first information may have the following manners.

Manner 1: A measurement result is fed back as valid; or a measurement result is fed back as invalid.

In Manner 1, one bit may be indicated, where “O” indicates that the sensing measurement result is invalid, and “1” indicates that the sensing measurement result is valid.

In Manner 1, a plurality of bits (ceil (log2 (m)) bits are required if there are m states) may be fed back. For example, the validity of the measurement result is classified into different levels, that is, quality (an SNR, an RSRP, an RSSI, and a signal clutter ratio) of the target signal or a sensing performance indicator corresponding to the measurement result is different. Alternatively, if there are a plurality of thresholds (it is assumed that there are two thresholds) used to determine the validity of the measurement result, then there may be three states: both the two thresholds are invalid, a first threshold is valid and a second threshold is invalid, and the second threshold is valid (it is assumed that the second threshold has a higher requirement).

Manner 2: A measurement result is fed back as valid; or a measurement result is fed back as invalid; or a DTX is fed back, which may be specifically as follows:

One or more bits are fed back, which is specifically as described in the foregoing Manner 1, or a DTX is fed back, that is, signal sending is not performed on a specified feedback channel resource. For example, when a receive end detects no target signal or at least one of an SNR, an RSRP, an RSSI, or a signal clutter ratio of a detected target signal does not meet a threshold requirement, the DTX is fed back. That is, in this case, a reason for invalidity of the sensing measurement result may be indirectly fed back through the DTX.

Manner 3: A measurement result is fed back as valid and a sensing measurement result is fed back; or a measurement result is fed back as invalid, which may be specifically as follows:

When the sensing measurement result is valid, “1” is fed back to indicate that a sensing result is valid, and the sensing measurement result is fed back. When the sensing measurement result is invalid, “0” is fed back to indicate that a sensing result is invalid.

Manner 4: A measurement result is fed back as valid and a sensing measurement result is fed back; or a measurement result is fed back as invalid and a reason for invalidity is fed back, which may be specifically as follows:

When the sensing measurement result is valid, “1” is fed back to indicate that a sensing result is valid, and the sensing measurement result is fed back. When the sensing measurement result is invalid, “0” is fed back to indicate that a sensing result is invalid, and the reason for the invalidity of the sensing measurement result is fed back.

Manner 5: A measurement result is fed back as valid and a sensing measurement result is fed back; or a measurement result is fed back as invalid and a recommend parameter configuration of a target signal is fed back, which may be specifically as follows:

When the sensing measurement result is valid, “1” is fed back to indicate that a sensing result is valid, and the sensing measurement result is fed back. When the sensing measurement result is invalid, “0” is fed back to indicate that a sensing result is invalid, and the recommend parameter configuration of the target signal is fed back.

Manner 6: A measurement result is fed back as valid and a sensing measurement result is fed back; or a measurement result is fed back as invalid and a reason for invalidity and a recommend parameter configuration of a target signal are fed back, which may be specifically as follows: When the sensing measurement result is valid, “1” is fed back to indicate that a sensing result is valid, and the sensing measurement result is fed back. When the sensing measurement result is invalid, “0” is fed back to indicate that a sensing result is invalid, and the reason for the invalidity of the sensing measurement result and the recommend parameter configuration of the target signal are fed back.

Manner 7: A measurement result is fed back as valid; or a measurement result is fed back as invalid and a reason for invalidity is fed back, which may be specifically as follows:

When the sensing measurement result is valid, “1” is fed back to indicate that a sensing result is valid. When the sensing measurement result is invalid, “0” is fed back to indicate that a sensing result is invalid, and the reason for the invalidity of the sensing measurement result is fed back.

Manner 8: A measurement result is fed back as valid; or a measurement result is fed back as invalid and a recommend parameter configuration of a target signal is fed back, which may be specifically as follows:

When the sensing measurement result is valid, “1” is fed back to indicate that a sensing result is valid. When the sensing measurement result is invalid, “0” is fed back to indicate that a sensing result is invalid, and the recommend parameter configuration of the target signal is fed back.

Manner 9: A measurement result is fed back as valid; or a measurement result is fed back as invalid and a reason for invalidity and a recommend parameter configuration of a target signal are fed back, which may be specifically as follows:

When the sensing measurement result is valid, “1” is fed back to indicate that a sensing result is valid. When the sensing measurement result is invalid, “0” is fed back to indicate that a sensing result is invalid, and the reason for the invalidity of the sensing measurement result and the recommend parameter configuration of the target signal are fed back.

Manner 10: Only when a measurement result is invalid, that a sensing measurement result is invalid and/or a reason for invalidity and/or a recommended parameter configuration of a target signal is fed back; and when a measurement result is valid, nothing is fed back.

Manner 11: Only when a measurement result is valid, that a sensing measurement result is valid and/or a sensing measurement result is fed back; and when a measurement result is invalid, nothing is fed back.

In addition, in this embodiment of this application, the sensing measurement result, the sensing requirement, and the sensing service may be defined as follows.

The foregoing sensing measurement result is a measurement result associated with a sensing measurement item, that is, a value of the measurement amount. Specifically, the sensing measurement result may include at least one of the following:
original channel information: channel matrix H information or information about compressed quantization of H, channel state information (CSI), such as an amplitude of a frequency domain channel response, a square sum and/or a phase of the amplitude of the frequency domain channel response, or an I-channel and Q-channel signal feature of a frequency domain channel response, such as an amplitude of an I-channel and/or Q-channel signal or a square of the amplitude;
signal strength information: an RSRP, and an RSSI;
spectrum information: a power-delay profile (PDP), a Doppler power spectrum, a power azimuth spectrum (PAS), pseudo-spectrum (such as a MUSIC spectrum) information, a delay-Doppler two-dimensional spectrum, a delay-Doppler-angle three-dimensional spectrum;
multi-path information: a power, a phase, a delay, and angle information of each path (including at least a first path, a LOS path, a first-order reflection path, and a multi-order reflection path) in a multi-path channel;
angle information: an angle of arrival and an angle of departure (including angle information on a terminal side, angle information on a base station side, and angle information of a reflection point);
difference information of signals corresponding to different antennas: a quotient or conjugate multiplication of frequency domain channel responses of a first antenna and a second antenna (or an amplitude or a phase of a quotient or conjugate multiplication of frequency domain channel responses of a first antenna and a second antenna; an I-channel or a Q-channel of a quotient or conjugate multiplication of frequency domain channel responses of a first antenna and a second antenna; or a projection operation of an I-channel or a Q-channel of a quotient or conjugate multiplication of frequency domain channel responses of a first antenna and a second antenna. The projection operation may be I*cos (theta)+Q*sin (theta), where theta is a value of an angle, different theta corresponds to different projections, I represents I-channel data, and Q represents Q-channel data); an amplitude ratio or amplitude difference between received signals of the first antenna and the second antenna, a phase difference between signals of the first antenna and the second antenna, and a time delay difference between signals of the first antenna and the second antenna; or
target parameter information determined based on original channel information: a Doppler spread, a Doppler frequency shift, a maximum delay spread, an angle spread, a coherent bandwidth, and coherent time.

In addition to the foregoing measurement amounts, a new measurement amount generated by performing an operation based on two or more of the foregoing measurement amounts is further included.

The foregoing sensing requirement information may include at least one of the following:
a sensing service type, for example, intrusion detection, track tracing, environment reconstruction, respiration detection, action identification, and the like;
a sensing area, for example, geographic coordinates of the sensing area, as well as a length, a width, a height, a range, an angle range, and the like of the sensing area;
a sensing target type, for example, a car, a motorcycle, a pedestrian, and the like, which indicates a moving velocity range of a sensing target and a reflected power level of a wireless signal;
sensing/integrated communication and sensing QoS, for example, a priority of a sensing/integrated communication and sensing service, a sensing resolution requirement, a sensing precision or sensing error requirement, a sensing delay budget, a maximum sensing range requirement, a continuous sensing capability requirement, a sensing update frequency requirement, a detection probability, a false alarm probability, and a missing detection probability requirement, and the like;
communication QoS (for an integrated communication and sensing service), for example, a communication delay budget, a false positive rate, and the like;
a quantity of sensing targets in the sensing area; or
a density of sensing targets in the sensing area.

The foregoing sensing service may be but is not limited to at least one of the following:
object feature detection: information that can reflect an attribute or a status of a target object may be at least one of the following: existence of a target object, a location of the target object, a velocity of the target object, an acceleration of the target object, a material of the target object, a shape of the target object, a type of the target object, a radar cross section (Radar Cross Section, RCS) of the target object, a polarization scattering feature, or the like;
event detection: information related to a target event is information that can be detected/sensed when the target event occurs, and may be: falling down detection, intrusion detection, quantity statistics, indoor positioning, gesture recognition, lip language recognition, gait recognition, expression recognition, breath monitoring, heart rate monitoring, sound source discrimination, and the like; or
environment detection: humidity, brightness, temperature, humidity, atmospheric pressure, air quality, weather conditions, terrain, construction/vegetation distribution, population statistics, population density, vehicle density, and the like.

In this embodiment of this application, the criterion for determining whether the sensing measurement result is valid may include at least one of the following:
whether quality (including at least one of an SNR, an RSRP, an RSSI, or a signal clutter ratio) of a target signal detected by a receive end meets a threshold requirement;
whether a sensing measurement result obtained by the receive end meets a sensing requirement, that is, whether a sensing performance indicator corresponding to a calculated sensing measurement result meets a requirement, where the sensing performance indicator may be at least one of the following:
sensing accuracy or a sensing error, a sensing resolution, a sensing range, a sensing delay, a detection probability, a false alarm probability, a quantity of targets that are detected simultaneously, a signal clutter ratio, a signal sidelobe characteristic (signal main lobe sidelobe ratio), a peak-to-average power ratio (PAPR), a variance, a standard deviation, and a ratio of a target sensing signal component to another sensing signal component, for example, with an amplitude corresponding to a sample point with a largest amplitude of a Doppler field in respiration detection being a target sensing component, that is, it is considered that the sample point with the largest amplitude is a sample point corresponding to a respiration frequency, and an amplitude corresponding to another sample point except the sample point with the largest amplitude being another sensing signal component;
whether the receive end demodulates the data correctly, performs sensing based on the communication data, and uses a manner in which a sensing parameter is first demodulated and then estimated; if communication demodulation fails, the sensing measurement result is affected and becomes unreliable; or
whether the receive end successfully obtains the sensing measurement result when a feedback time point arrives, for example, whether the sensing measurement result processing times out.

When the sensing measurement result meets at least one of the foregoing items, it is considered that the sensing measurement result is valid; otherwise, it is considered that the sensing measurement result is invalid. For example, when the first item and the second item are met, that is, quality of the target signal meets a threshold requirement and the sensing measurement result meets a sensing requirement, it is considered that the sensing measurement result is valid.

In this embodiment of this application, the first device performs sensing measurement based on indication information related to a configuration of a sensing measurement signal, feeds back validity of a sensing measurement result, and feeds back information such as the sensing measurement result, a reason for invalidity of the sensing measurement result, and a recommended configuration of a sensing measurement signal based on the validity of the sensing measurement result. Determining a feedback format based on the validity of the sensing measurement result may reduce overheads, facilitate a party that receives the sensing measurement result to further process the sensing measurement result, or adjust the configuration of the sensing measurement signal, so as to obtain better sensing measurement performance.

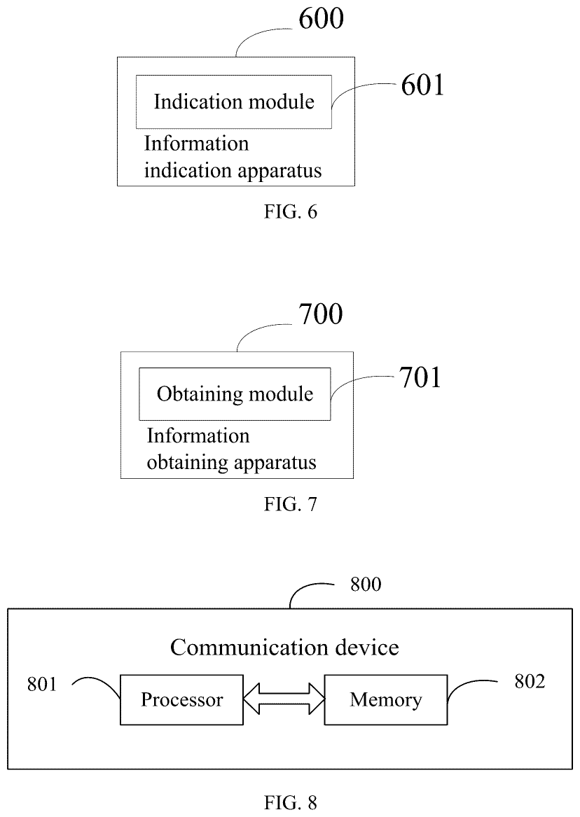

FIG. 6 is a diagram of a structure of an information indication apparatus according to an embodiment of this application. As shown in FIG. 6, the apparatus includes:
an indication module 601, configured to indicate first information to a second device, where the first information is used to indicate validity of a sensing measurement result; and
the sensing measurement result is a measurement result obtained by performing sensing measurement on a target signal received by a first device.

Optionally, the first information includes an indication bit, and the indication bit is at least one bit and is used to indicate validity of a sensing measurement result.

Optionally, the indication bit is one bit, where a first value of the bit indicates that the sensing measurement result is valid, and a second value of the bit indicates that the sensing measurement result is invalid.

Optionally, the indication bit is m bits, where m is an integer greater than 1, and the m bits indicate a validity level of the sensing measurement result.

Optionally, that a first device indicates validity of a sensing measurement result to a second device includes:

The first device indicates the validity of the sensing measurement result to the second device through a discontinuous transmission (DTX).

Optionally, in a case that the sensing measurement result is invalid, the first device does not send a signal on a first feedback resource that is used to indicate validity of a sensing measurement result, so as to indicate through a DTX that the sensing measurement result is invalid to the second device.

Optionally, the first information is further used to indicate at least one of the following:
a reason for invalidity of the sensing measurement result; or
a parameter configuration of the target signal.

Optionally, the reason for the invalidity of the sensing measurement result includes at least one of the following:
quality of the target signal detected by the first device does not meet a threshold requirement;
the sensing measurement result obtained by the first device does not meet a sensing requirement;
in a case that the target signal is a communication data signal, the first device does not demodulate the data correctly; or
when a feedback time point of the first information arrives, the first device does not obtain the sensing measurement result.

Optionally, the parameter configuration includes at least one of the following:
a waveform, subcarrier spacing, a guard interval, a bandwidth, burst duration, a time domain interval, transmit signal power, a signal format, a signal direction, a time resource, a frequency domain resource, or a quasi co-location (QCL) relationship.

Optionally, the first information is further used to indicate at least one of the following:
identification information of the target signal associated with the sensing measurement result;
identification information of a sensing measurement; or
the sensing measurement result.

Optionally, in a case that the sensing measurement result is valid, the first device indicates the first information to the second device; and in a case that the sensing measurement result is invalid, the first device does not send the first information to the second device; or
in a case that the sensing measurement result is invalid, the first device indicates the first information to the second device; and in a case that the sensing measurement result is valid, the first device does not indicate the first information to the second device.

Optionally, in a case that the first information indicates that the sensing measurement result is invalid, the first information is further used to indicate at least one of the following:
a reason for invalidity of the sensing measurement result; or
a parameter configuration of the target signal; or
in a case that the first information indicates that the sensing measurement result is valid, the first information is further used to indicate at least one of the following:
the sensing measurement result.

Optionally, the apparatus further includes:
a first receiving module, configured to receive second information sent by the second device, where the second information is used to indicate at least one of the following:
whether feedback on the validity of the sensing measurement result is needed;
a rule for feedback on the validity of the sensing measurement result;
a criterion for determining the validity of the sensing measurement result;
a sensing measurement item;
a sensing requirement; or
a sensing service.

Optionally, the rule for feedback on the validity of the sensing measurement result includes at least one of the following:
feedback timing;
a feedback resource;
a feedback manner; or
a format of the first information; or
the criterion for determining the validity of the sensing measurement result includes at least one of the following:
whether quality of the target signal detected by the first device meets a threshold requirement;
whether the sensing measurement result obtained by the first device meets a sensing requirement;
in a case that the target signal is a communication data signal, whether the first device demodulates the data correctly; or
when a feedback time point of the first information arrives, whether the first device obtains the sensing measurement result.

Optionally, the apparatus further includes:
a second receiving module, configured to receive third information sent by the second device, where the third information is used to indicate at least one of the following:
indication information that indicates whether sensing measurement is allowed to be performed based on a communication data signal;
configuration information of a communication data signal obtained by performing sensing measurement; or
sensing quality of service (QOS) information.

The foregoing information indication apparatus may implement sensing measurement.

The information indication apparatus in this embodiment of this application may be an electronic device, for example, an electronic device with an operating system, or may be a component in the electronic device, for example, an integrated circuit or a chip. For example, the electronic device may be a terminal, or another device other than the terminal. For example, the terminal may include but is not limited to the listed types of the terminal in this embodiment of this application. The another device may be a server, a network attached storage (NAS), or the like. This is not specifically limited in the embodiments of this application.

The information indication apparatus provided in this embodiment of this application can implement the processes implemented in the method embodiment shown in FIG. 4 and achieve a same technical effect. To avoid repetition, details are not described herein again.

FIG. 7 is a diagram of a structure of an information obtaining apparatus according to an embodiment of this application. As shown in FIG. 7, the apparatus includes:
an obtaining module 701, configured to obtain first information indicated by a first device, where the first information is used to indicate validity of a sensing measurement result; and
the sensing measurement result is a measurement result obtained by performing sensing measurement on a target signal received by the first device.

Optionally, the first information includes an indication bit, and the indication bit is at least one bit and is used to indicate validity of a sensing measurement result.

Optionally, the indication bit is one bit, where a first value of the bit indicates that the sensing measurement result is valid, and a second value of the bit indicates that the sensing measurement result is invalid.

Optionally, the indication bit is m bits, where m is an integer greater than 1, and the m bits indicate a validity level of the sensing measurement result.

Optionally, that a second device obtains first information indicated by a first device includes:

The second device obtains the first information through a discontinuous transmission (DTX) of the first device.

Optionally, in a case that the sensing measurement result is invalid, the second device does not detect a signal sent by the first device on a first feedback resource that is used to indicate validity of a sensing measurement result, so as to determine through the DTX that the sensing measurement result is invalid.

Optionally, the first information is further used to indicate at least one of the following:
a reason for invalidity of the sensing measurement result; or
a parameter configuration of the target signal.

Optionally, the reason for the invalidity of the sensing measurement result includes at least one of the following:
quality of the target signal detected by the first device does not meet a threshold requirement;
the sensing measurement result obtained by the first device does not meet a sensing requirement;
in a case that the target signal is a communication data signal, the first device does not demodulate the data correctly; or
when a feedback time point of the first information arrives, the first device does not obtain the sensing measurement result.

Optionally, the parameter configuration includes at least one of the following:
a waveform, subcarrier spacing, a guard interval, a bandwidth, burst duration, a time domain interval, transmit signal power, a signal format, a signal direction, a time resource, a frequency domain resource, or a quasi co-location (QCL) relationship.

Optionally, the first information is further used to indicate at least one of the following:
identification information of the target signal associated with the sensing measurement result;
identification information of a sensing measurement; or the sensing measurement result.

Optionally, in a case that the first information indicates that the sensing measurement result is invalid, the first information is further used to indicate at least one of the following:
a reason for invalidity of the sensing measurement result; or
a parameter configuration of the target signal; or
in a case that the first information indicates that the sensing measurement result is valid, the first information is further used to indicate at least one of the following:
the sensing measurement result.

Optionally, the apparatus further includes:
a first sending module, configured to send second information to the first device, where the second information is used to indicate at least one of the following:
whether feedback on the validity of the sensing measurement result is needed;
a rule for feedback on the validity of the sensing measurement result;
a criterion for determining the validity of the sensing measurement result;
a sensing measurement item;
a sensing requirement; or
a sensing service.

Optionally, the rule for feedback on the validity of the sensing measurement result includes at least one of the following:
feedback timing;
a feedback resource;
a feedback manner; or
a format of the first information; or
the criterion for determining the validity of the sensing measurement result includes at least one of the following:
whether quality of the target signal detected by the first device meets a threshold requirement;
whether the sensing measurement result obtained by the first device meets a sensing requirement;
in a case that the target signal is a communication data signal, whether the first device demodulates the data correctly; or
when a feedback time point of the first information arrives, whether the first device obtains the sensing measurement result.

Optionally, the apparatus further includes:
a second sending module, configured to send third information to the first device, where the third information is used to indicate at least one of the following:
indication information that indicates whether sensing measurement is allowed to be performed based on a communication data signal;
configuration information of a communication data signal obtained by performing sensing measurement; or sensing quality of service (QOS) information.

The foregoing information obtaining apparatus may implement sensing measurement.

The information obtaining apparatus in this embodiment of this application may be an electronic device, for example, an electronic device with an operating system, or may be a component in the electronic device, for example, an integrated circuit or a chip. For example, the electronic device may be a network side device, or another device other than the network side device. For example, the network side device may include but is not limited to the listed types of the network side device in this embodiment of this application. The another device may be a server, a network attached storage (NAS), or the like. This is not specifically limited in the embodiments of this application.

The information obtaining apparatus provided in this embodiment of this application can implement the processes implemented in the method embodiment shown in FIG. 5, and achieve a same technical effect. To avoid repetition, details are not provided herein again.

Optionally, as shown in FIG. 8, an embodiment of this application further provides a communication device 800, including a processor 801 and a memory 802. The memory 802 stores a program or an instruction that can be run on the processor 801. For example, when the communication device 800 is a first device, the program or the instruction is executed by the processor 801 to implement the steps of the foregoing information indication method embodiment, and a same technical effect can be achieved. When the communication device 800 is a second device, the program or the instruction is executed by the processor 801 to implement the steps of the foregoing information obtaining method embodiment, and a same technical effect can be achieved. To avoid repetition, details are not described herein again.

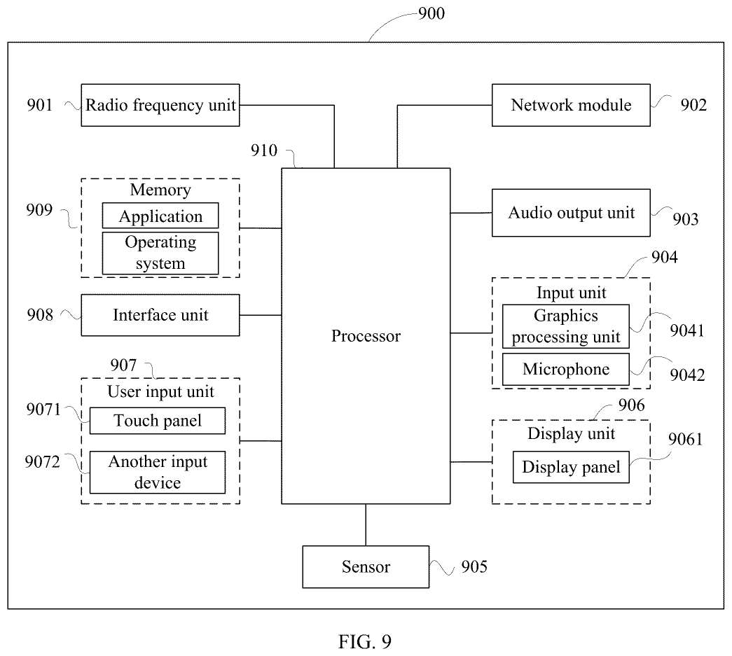

An embodiment of this application further provides a communication device. The communication device is a first device and includes a processor and a communication interface. The communication interface is configured to indicate first information to a second device, where the first information is used to indicate validity of a sensing measurement result, and the sensing measurement result is a measurement result obtained by performing sensing measurement on a target signal received by a first device. The first device embodiment corresponds to the foregoing method embodiment of the first device side. The implementation processes and implementations of the foregoing method embodiment may be applied to the first device embodiment, and a same technical effect can be achieved. Specifically, FIG. 9 is a schematic diagram of a hardware structure of a communication device for implementing the embodiments of this application.

The communication device 900 is a first device and includes, but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

A person skilled in the art can understand that the communication device 900 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 904 may include a graphics processing unit (GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Usually, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may be a volatile memory or a non-volatile memory, or the memory 909 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 909 in this embodiment of this application includes but is not limited to these memories and any memory of another proper type.

The processor 910 may include one or more processing units. Optionally, an application processor and a modem processor are integrated into the processor 910. The application processor mainly processes an operating system, a user interface, an application, or the like. The modem processor mainly processes a wireless communication signal, for example, a baseband processor. It may be understood that, alternatively, the foregoing modem processor may not be integrated into the processor 910.

The radio frequency unit 901 is configured to indicate first information to a second device, where the first information is used to indicate validity of a sensing measurement result; and
the sensing measurement result is a measurement result obtained by performing sensing measurement on a target signal received by a first device.

Optionally, the first information includes an indication bit, and the indication bit is at least one bit and is used to indicate validity of a sensing measurement result.

Optionally, the indication bit is one bit, where a first value of the bit indicates that the sensing measurement result is valid, and a second value of the bit indicates that the sensing measurement result is invalid.

Optionally, the indication bit is m bits, where m is an integer greater than 1, and the m bits indicate a validity level of the sensing measurement result.

Optionally, that a first device indicates validity of a sensing measurement result to a second device includes:

The first device indicates the validity of the sensing measurement result to the second device through a discontinuous transmission (DTX).

Optionally, in a case that the sensing measurement result is invalid, the first device does not send a signal on a first feedback resource that is used to indicate validity of a sensing measurement result, so as to indicate through a DTX that the sensing measurement result is invalid to the second device.

Optionally, the first information is further used to indicate at least one of the following:
a reason for invalidity of the sensing measurement result; or
a parameter configuration of the target signal.

Optionally, the reason for the invalidity of the sensing measurement result includes at least one of the following:
quality of the target signal detected by the first device does not meet a threshold requirement;
the sensing measurement result obtained by the first device does not meet a sensing requirement;
in a case that the target signal is a communication data signal, the first device does not demodulate the data correctly; or
when a feedback time point of the first information arrives, the first device does not obtain the sensing measurement result.

Optionally, the parameter configuration includes at least one of the following:
a waveform, subcarrier spacing, a guard interval, a bandwidth, burst duration, a time domain interval, transmit signal power, a signal format, a signal direction, a time resource, a frequency domain resource, or a quasi co-location (QCL) relationship.

Optionally, the first information is further used to indicate at least one of the following:
identification information of the target signal associated with the sensing measurement result;
identification information of a sensing measurement; or
the sensing measurement result.

Optionally, in a case that the sensing measurement result is valid, the first device indicates the first information to the second device; and in a case that the sensing measurement result is invalid, the first device does not send the first information to the second device; or
in a case that the sensing measurement result is invalid, the first device indicates the first information to the second device; and in a case that the sensing measurement result is valid, the first device does not indicate the first information to the second device.

Optionally, in a case that the first information indicates that the sensing measurement result is invalid, the first information is further used to indicate at least one of the following:
a reason for invalidity of the sensing measurement result; or
a parameter configuration of the target signal; or
in a case that the first information indicates that the sensing measurement result is valid, the first information is further used to indicate at least one of the following:
the sensing measurement result.

Optionally, before indicating the first information to the second device, the radio frequency unit 901 is further configured to:
receive second information sent by the second device, where the second information is used to indicate at least one of the following:
whether feedback on the validity of the sensing measurement result is needed;
a rule for feedback on the validity of the sensing measurement result;
a criterion for determining the validity of the sensing measurement result;
a sensing measurement item;
a sensing requirement; or
a sensing service.

Optionally, the rule for feedback on the validity of the sensing measurement result includes at least one of the following:
feedback timing;
a feedback resource;
a feedback manner; or
a format of the first information; or
the criterion for determining the validity of the sensing measurement result includes at least one of the following:
whether quality of the target signal detected by the first device meets a threshold requirement;
whether the sensing measurement result obtained by the first device meets a sensing requirement;
in a case that the target signal is a communication data signal, whether the first device demodulates the data correctly; or
when a feedback time point of the first information arrives, whether the first device obtains the sensing measurement result.

Optionally, before indicating the first information to the second device, the radio frequency unit 901 is further configured to:
receive third information sent by the second device, where the third information is used to indicate at least one of the following:
indication information that indicates whether sensing measurement is allowed to be performed based on a communication data signal;
configuration information of a communication data signal obtained by performing sensing measurement; or
sensing quality of service (QOS) information.

It should be noted that this embodiment is described by using an example in which the first device is a terminal.

The foregoing first device may implement sensing measurement.

An embodiment of this application further provides a communication device. The communication device is a second device and includes a processor and a communication interface. The communication interface is configured to obtain first information indicated by a first device, where the first information is used to indicate validity of a sensing measurement result, and the sensing measurement result is a measurement result obtained by performing sensing measurement on a target signal received by the first device. The second device embodiment corresponds to the foregoing method embodiment of the second device. The implementation processes and implementations of the foregoing method embodiment may be applied to the second device embodiment, and a same technical effect can be achieved.

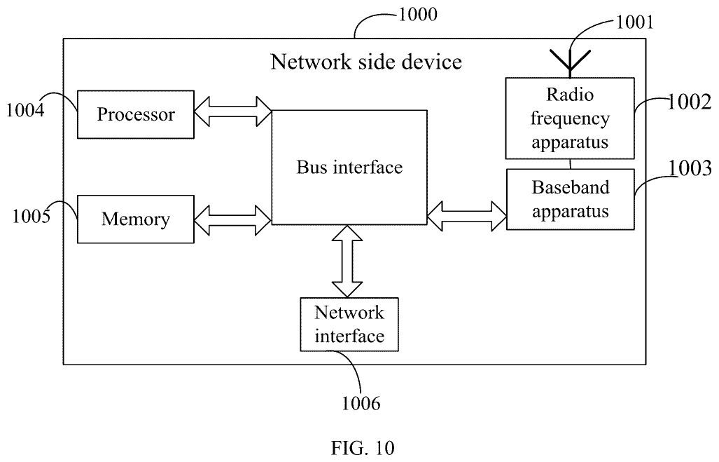

Specifically, an embodiment of this application further provides a communication device, and the communication device is a second device. As shown in FIG. 10, the communication device 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information by using the antenna 1001, and sends the received information to the baseband apparatus 1003 for processing. In a downlink direction, the baseband apparatus 1003 processes information that needs to be sent, and sends processed information to the radio frequency apparatus 1002. The radio frequency apparatus 1002 processes the received information, and sends processed information by using the antenna 1001.

In the foregoing embodiment, the method performed by the communication device may be implemented in the baseband apparatus 1003. The baseband apparatus 1003 includes a baseband processor.

For example, the baseband apparatus 1003 may include at least one baseband board. A plurality of chips are disposed on the baseband board. As shown in FIG. 10, one chip is, for example, a baseband processor, and is connected to the memory 1005 by using a bus interface, to invoke a program in the memory 1005 to perform the operations of the network device shown in the foregoing method embodiment.

The communication device may further include a network interface 1006, and the interface is, for example, a common public radio interface (CPRI).

Specifically, the communication device 1000 in this embodiment of this application further includes an instruction or a program that is stored in the memory 1005 and that can be run on the processor 1004. The processor 1004 invokes the instruction or the program in the memory 1005 to perform the method performed by the modules shown in FIG. 4, and a same technical effect is achieved. To avoid repetition, details are not described herein again.

The radio frequency apparatus 1002 is configured to obtain first information indicated by a first device, where the first information is used to indicate validity of a sensing measurement result; and
the sensing measurement result is a measurement result obtained by performing sensing measurement on a target signal received by the first device.

Optionally, the first information includes an indication bit, and the indication bit is at least one bit and is used to indicate validity of a sensing measurement result.

Optionally, the indication bit is one bit, where a first value of the bit indicates that the sensing measurement result is valid, and a second value of the bit indicates that the sensing measurement result is invalid.

Optionally, the indication bit is m bits, where m is an integer greater than 1, and the m bits indicate a validity level of the sensing measurement result.

Optionally, that a second device obtains first information indicated by a first device includes:

The second device obtains the first information through a discontinuous transmission (DTX) of the first device.

Optionally, in a case that the sensing measurement result is invalid, the second device does not detect a signal sent by the first device on a first feedback resource that is used to indicate validity of a sensing measurement result, so as to determine through the DTX that the sensing measurement result is invalid.

Optionally, the first information is further used to indicate at least one of the following:
a reason for invalidity of the sensing measurement result; or
a parameter configuration of the target signal.

Optionally, the reason for the invalidity of the sensing measurement result includes at least one of the following:
quality of the target signal detected by the first device does not meet a threshold requirement;
the sensing measurement result obtained by the first device does not meet a sensing requirement;
in a case that the target signal is a communication data signal, the first device does not demodulate the data correctly; or
when a feedback time point of the first information arrives, the first device does not obtain the sensing measurement result.

Optionally, the parameter configuration includes at least one of the following:
a waveform, subcarrier spacing, a guard interval, a bandwidth, burst duration, a time domain interval, transmit signal power, a signal format, a signal direction, a time resource, a frequency domain resource, or a quasi co-location (QCL) relationship.

Optionally, the first information is further used to indicate at least one of the following:
identification information of the target signal associated with the sensing measurement result;
identification information of a sensing measurement; or
the sensing measurement result.

Optionally, in a case that the first information indicates that the sensing measurement result is invalid, the first information is further used to indicate at least one of the following:
a reason for invalidity of the sensing measurement result; or
a parameter configuration of the target signal; or
in a case that the first information indicates that the sensing measurement result is valid, the first information is further used to indicate at least one of the following:
the sensing measurement result.

Optionally, before obtaining first information indicated by a first device, the radio frequency apparatus 1002 is further configured to:
send second information to the first device, where the second information is used to indicate at least one of the following:
whether feedback on the validity of the sensing measurement result is needed;
a rule for feedback on the validity of the sensing measurement result;
a criterion for determining the validity of the sensing measurement result;
a sensing measurement item;
a sensing requirement; or
a sensing service.

Optionally, the rule for feedback on the validity of the sensing measurement result includes at least one of the following:
feedback timing;
a feedback resource;
a feedback manner; or
a format of the first information; or
the criterion for determining the validity of the sensing measurement result includes at least one of the following:
whether quality of the target signal detected by the first device meets a threshold requirement;
whether the sensing measurement result obtained by the first device meets a sensing requirement;
in a case that the target signal is a communication data signal, whether the first device demodulates the data correctly; or
when a feedback time point of the first information arrives, whether the first device obtains the sensing measurement result.

Optionally, before obtaining first information indicated by a first device, the radio frequency apparatus 1002 is further configured to:
send third information to the first device, where the third information is used to indicate at least one of the following:
indication information that indicates whether sensing measurement is allowed to be performed based on a communication data signal;
configuration information of a communication data signal obtained by performing sensing measurement; or
sensing quality of service (QOS) information.

It should be noted that this embodiment is described by using an example in which the second device is a network side device.

The foregoing second device may implement sensing measurement.

An embodiment of this application further provides a readable storage medium, where the readable storage medium stores a program or an instruction, and the program or the instruction is executed by a processor to implement the processes of the information indication method embodiment or the information obtaining method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor, and the processor is configured to run a program or an instruction to implement the processes of the foregoing information indication method embodiment or information obtaining method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing information indication method embodiment or information obtaining method embodiment, and a same technical effect can be achieved. To avoid repetition, details are not described herein again.

An embodiment of this application further provides an information feedback system, including a first device and a second device, where the first device is configured to perform the steps of the foregoing information indication method, and the second device is configured to perform the steps of the foregoing information obtaining method.

A person of ordinary skill in the art may be aware that, in combination with the examples described in the embodiments disclosed in this specification, units and algorithm steps may be implemented by using electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of the present disclosure.

It can be clearly understood by a person skilled in the art that, for the purpose of convenient and brief description, for a detailed operating process of the foregoing system, apparatus, and unit, refer to a corresponding process in the foregoing method embodiments. Details are not described herein again.

In the embodiments provided in this application, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions in the embodiments.

In addition, functional units in the embodiments of the present disclosure may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions of the present disclosure essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a ROM, a RAM, a magnetic disk, or an optical disc.

A person of ordinary skill in the art may understand that all or some of the processes of the methods in the embodiments may be implemented by a computer program controlling related hardware. The program may be stored in a computer readable storage medium. When the program runs, the processes of the methods in the embodiments are performed. The storage medium may include: a magnetic disk, an optical disc, a read-only memory (ROM), a random access memory (RAM), or the like.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An information indication method, comprising:
indicating, by a first device, first information to a second device, wherein the first information is used to indicate validity of a sensing measurement result; and
the sensing measurement result is a measurement result obtained by performing sensing measurement on a target signal received by the first device.

2. The method according to claim 1, wherein the first information comprises an indication bit, and the indication bit is at least one bit and is used to indicate validity of a sensing measurement result.

3. The method according to claim 2, wherein the indication bit is one bit, a first value of the bit indicates that the sensing measurement result is valid, and a second value of the bit indicates that the sensing measurement result is invalid.

4. The method according to claim 2, wherein the indication bit is m bits, m is an integer greater than 1, and the m bits indicate a validity level of the sensing measurement result.

5. The method according to claim 1, wherein the indicating, by a first device, validity of a sensing measurement result to a second device comprises:
The first device indicates the validity of the sensing measurement result to the second device through a discontinuous transmission (DTX).

6. The method according to claim 5, wherein in a case that the sensing measurement result is invalid, skipping sending, by the first device, a signal on a first feedback resource that is used to indicate validity of a sensing measurement result, so as to indicate through a DTX that the sensing measurement result is invalid to the second device.

7. The method according to claim 1, wherein the first information is further used to indicate at least one of the following:
a reason for invalidity of the sensing measurement result; or
a parameter configuration of the target signal.

8. The method according to claim 7, wherein the reason for the invalidity of the sensing measurement result comprises at least one of the following:
quality of the target signal detected by the first device does not meet a threshold requirement;
the sensing measurement result obtained by the first device does not meet a sensing requirement;
in a case that the target signal is a communication data signal, the first device does not demodulate the data correctly; or
when a feedback time point of the first information arrives, the first device does not obtain the sensing measurement result;
or,
wherein the parameter configuration comprises at least one of the following:
a waveform, subcarrier spacing, a guard interval, a bandwidth, burst duration, a time domain interval, transmit signal power, a signal format, a signal direction, a time resource, a frequency domain resource, or a quasi co-location (QCL) relationship.

9. The method according to claim 1, wherein the first information is further used to indicate at least one of the following:
identification information of the target signal associated with the sensing measurement result;
identification information of a sensing measurement; or
the sensing measurement result.

10. The method according to claim 1, wherein in a case that the sensing measurement result is valid, indicating, by the first device, the first information to the second device; and in a case that the sensing measurement result is invalid, skipping indicating, by the first device, the first information to the second device; or
in a case that the sensing measurement result is invalid, indicating, by the first device, the first information to the second device; and in a case that the sensing measurement result is valid, skipping indicating, by the first device, the first information to the second device;
or,
wherein in a case that the first information indicates that the sensing measurement result is invalid, the first information is further used to indicate at least one of the following:
a reason for invalidity of the sensing measurement result; or
a parameter configuration of the target signal; or
in a case that the first information indicates that the sensing measurement result is valid, the first information is further used to indicate at least one of the following:
the sensing measurement result.

11. The method according to claim 1, wherein before the indicating, by a first device, first information to a second device, the method further comprises:
receiving, by the first device, second information sent by the second device, wherein the second information is used to indicate at least one of the following:
whether feedback on the validity of the sensing measurement result is needed;
a rule for feedback on the validity of the sensing measurement result;
a criterion for determining the validity of the sensing measurement result;
a sensing measurement item;
a sensing requirement; or
a sensing service;
wherein the rule for feedback on the validity of the sensing measurement result comprises at least one of the following:
feedback timing;
a feedback resource;
a feedback manner; or
a format of the first information; or
the criterion for determining the validity of the sensing measurement result comprises at least one of the following:
whether quality of the target signal detected by the first device meets a threshold requirement;
whether the sensing measurement result obtained by the first device meets a sensing requirement;
in a case that the target signal is a communication data signal, whether the first device demodulates the data correctly; or
when a feedback time point of the first information arrives, whether the first device obtains the sensing measurement result;
or,
wherein before the indicating, by a first device, first information to a second device, the method further comprises:
receiving, by the first device, third information sent by the second device, wherein the third information is used to indicate at least one of the following:
indication information that indicates whether sensing measurement is allowed to be performed based on a communication data signal;
configuration information of a communication data signal obtained by performing sensing measurement; or
sensing quality of service (QOS) information.

12. An information obtaining method, comprising:
obtaining, by a second device, first information indicated by a first device, wherein the first information is used to indicate validity of a sensing measurement result; and
the sensing measurement result is a measurement result obtained by performing sensing measurement on a target signal received by the first device.

13. The method according to claim 12, wherein the first information comprises an indication bit, and the indication bit is at least one bit and is used to indicate validity of a sensing measurement result.

14. The method according to claim 13, wherein the indication bit is one bit, a first value of the bit indicates that the sensing measurement result is valid, and a second value of the bit indicates that the sensing measurement result is invalid.

15. The method according to claim 13, wherein the indication bit is m bits, m is an integer greater than 1, and the m bits indicate a validity level of the sensing measurement result.

16. The method according to claim 12, wherein the obtaining, by a second device, first information indicated by a first device comprises:
obtaining, by the second device, the first information through a discontinuous transmission (DTX) of the first device;
wherein in a case that the sensing measurement result is invalid, skipping detecting, by the second device, a signal sent by the first device on a first feedback resource that is used to indicate validity of a sensing measurement result, so as to determine through the DTX that the sensing measurement result is invalid.

17. The method according to claim 12, wherein the first information is further used to indicate at least one of the following:
a reason for invalidity of the sensing measurement result; or
a parameter configuration of the target signal;
or,
wherein the first information is further used to indicate at least one of the following:
identification information of the target signal associated with the sensing measurement result;
identification information of a sensing measurement; or
the sensing measurement result.

18. The method according to claim 12, wherein before the obtaining, by a second device, first information indicated by a first device, the method further comprises:
sending, by the second device, second information to the first device, wherein the second information is used to indicate at least one of the following:
whether feedback on the validity of the sensing measurement result is needed;
a rule for feedback on the validity of the sensing measurement result;
a criterion for determining the validity of the sensing measurement result;
a sensing measurement item;
a sensing requirement; or
a sensing service;
or,
wherein before the obtaining, by a second device, first information indicated by a first device, the method further comprises:
sending, by the second device, third information to the first device, wherein the third information is used to indicate at least one of the following:
indication information that indicates whether sensing measurement is allowed to be performed based on a communication data signal;
configuration information of a communication data signal obtained by performing sensing measurement; or
sensing quality of service (QOS) information.

19. A communication device, wherein the communication device is a first device and comprises a processor and a memory, the memory stores a program or an instruction that can be run on the processor, wherein the program or the instruction, when executed by the processor, causes the communication device to perform:
indicating first information to a second device, wherein the first information is used to indicate validity of a sensing measurement result; and
the sensing measurement result is a measurement result obtained by performing sensing measurement on a target signal received by the first device.

20. A communication device, wherein the communication device is a second device and comprises a processor and a memory, the memory stores a program or an instruction that can be run on the processor, and the program or the instruction is executed by the processor to implement the steps of the information obtaining method according to claim 12.
